(19) United States
(12) Patent Application Publication
(10) Pub. No.: US 2014/0179142 A1
(43) Pub. Date: Jun. 26, 2014

(54) SWITCH ARRANGEMENT FOR ESTABLISHING AND/OR DISCONNECTING A CONNECTION BETWEEN A CONNECTOR AND A MATING-CONNECTOR

(71) Applicants: Lothar Winzen, Unkell (DE); Thomas Freyermuth, Kalenborn (DE); Thomas Konietzko, Niederkassel (DE); Stephan Stanke, Rheinbach (DE); Guenter Baujan, Troisdorf (DE); Luis Javier Puras Trueba, Mannheim (DE); Christian Schrettlinger, Bensheim (DE); Rudolf Kraemer, Lautertal (DE); Mohamed Aboulkassem, Darmstadt (DE); Bert Bergner, Bensheim (DE)

(72) Inventors: Lothar Winzen, Unkell (DE); Thomas Freyermuth, Kalenborn (DE); Thomas Konietzko, Niederkassel (DE); Stephan Stanke, Rheinbach (DE); Guenter Baujan, Troisdorf (DE); Luis Javier Puras Trueba, Mannheim (DE); Christian Schrettlinger, Bensheim (DE); Rudolf Kraemer, Lautertal (DE); Mohamed Aboulkassem, Darmstadt (DE); Bert Bergner, Bensheim (DE)

(73) Assignees: TYCO ELECTRONICS AMP GMBH, Bensheim (DE); EATON ELECTRICAL IP GMBH & CO. KG, Schoenefeld (DE)

(21) Appl. No.: 14/233,890

(22) PCT Filed: Jul. 23, 2012
(86) PCT No.: PCT/EP2012/064414

§ 371 Date: Mar. 13, 2014

(30) Foreign Application Priority Data
Jul. 21, 2011 (EP) 11174920.6

(51) Int. Cl. H01R 13/621

(52) U.S. Cl. CPC H01R 13/6215
USPC 439/304

(57) ABSTRACT

A switching arrangement includes a plug and a complementary mating plug for establishing and separating a connection between the plug and the mating plug. The plug includes a locking bolt disposed rotationally about an axis. The locking bolt includes a thread and the mating plug includes a mating thread. The plug is lockable to the mating plug by driving in the thread of the locking bolt into the mating thread. The switching device is configured to be moved to a connected position by driving in the thread of the locking bolt into the mating thread, and thereby providing a movement of the plug relative to the mating plug, and is configured to be moved to a disconnected position by driving out the thread of the locking bolt from the mating thread, thereby providing the movement of the plug relative to the mating plug.

### CROSS-REFERENCE TO PRIOR APPLICATIONS

This application is a U.S. National Phase Application under 35 U.S.C. §371 of International Application No. PCT/EP2012/064414, filed on Jul. 23, 2012, and claims benefit to European Patent Application No. EP 11174920.6, filed on Jul. 21, 2011. The International Application was published in German on Jan. 24, 2013 as WO 2013/011151 under PCT Article 21(2).

### FIELD

The invention concerns a switching device with a plug and a complementary mating plug for establishing and/or separating the connection between the plug and the mating plug, whereby the mating plug is particularly attached to a circuit breaker and whereby the plug is particularly attached to a replaceable auxiliary module of the circuit breaker.

### BACKGROUND

Switching arrangements of plugs and complementary mating plugs, especially circuit breakers with auxiliary modules, are used, among others, in case of switching devices, switches and especially switches with accessories, for example with an adapter. The connection between a plug and a complementary mating plug, each with several contacts that can be connected to electrical conductors, is generally established or separated by plugging in or removing by hand.

DE 10 2009 023 347 A1 concerns a manually operated circuit breaker with a manually operated handle rotating around an axis, and a pluggable, replaceable auxiliary module, whereby the circuit breaker is fitted with a locking device for locking the auxiliary module, which is movable between an unlocked position and a locked position. In case of a circuit breaker with a modular structure, removal of the modules in the switched-on state is prevented by mechanical locking mechanisms. The circuit breaker generates an electronic status message on the locking or switching status of the auxiliary module, whereby the position of the locking device is transferred by a power transmission element to a microswitch in the auxiliary module such that consequently the microswitch is switched on and off respectively depending on the position of the locking device.

The microswitch controls an electronic circuit, which can transfer the status information to a connected evaluation system.

### SUMMARY

In an embodiment, the present invention provides a switching arrangement including a plug and a complementary mating plug for establishing and separating a connection between the plug and the mating plug. The plug includes a locking bolt disposed rotationally about an axis. The locking bolt includes a thread and the mating plug includes a mating thread. The plug is lockable to the mating plug by driving in the thread of the locking bolt into the mating thread. The switching device is configured to be moved to a connected position by driving in the thread of the locking bolt into the mating thread, and thereby providing a movement of the plug relative to the mating plug, and is configured to be moved to a disconnected position by driving out the thread of the locking bolt from the mating thread, thereby providing the movement of the plug relative to the mating plug.

### BRIEF DESCRIPTION OF THE DRAWINGS

The present invention will be described in even greater detail below based on the exemplary figures. The invention is not limited to the exemplary embodiment. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a perspective view of an embodiment of an arrangement according to the present invention in the disconnected state;

FIGS. 2 to 4 shows the embodiment according to FIG. 1 in different stages of the connection process;

FIG. 5 shows the embodiment according to FIG. 1 in the connected and secured state;

FIG. 6 shows a detailed view of the locking bolt; and

FIG. 7 shows the embodiment according to FIG. 1 in an exploded perspective view.

### DETAILED DESCRIPTION

The present invention recognizes that state of the art circuit breakers with a modular structure have the disadvantage that plugging in the plug module to the circuit breaker requires a significant amount of force to establish the locked state depending on the type of the plug and the number and layout of the contacts to be connected. The amount of force required here increases during the plugging-in process, as the contacts increasingly engage each other, whereby friction increases. In case of a required effort of 120 Newton for example in the range of a few millimetres prior to the completely plugged-in position, a significant risk of injury exists during the manual connecting and especially disconnecting process of the plug. For example, if a switching device is installed overhead in an unfavourable position, and a person standing on a ladder must pull off a trigger module from the circuit breaker, the person can fall off due to the unexpected separation of the connection.

In an embodiment, the invention simplifies the establishment and/or separation of a connection between a plug and a mating plug especially in the areas where a considerable amount of force is required for establishing or separating the connection.

The switching arrangement according to an embodiment of the invention comprises a plug and a complementary mating plug, and there is a locking bolt rotating around an axis attached to the plug for establishing and/or separating the connection between the plug and the mating plug, whereby the locking bolt has a thread and the mating plug has a mating thread. According to an embodiment of the invention, the connection between the plug and the mating plug is established by driving in the thread of the locking bolt into the mating thread. With respect to an embodiment of the invention, the terms plug and mating plug are not specific, and they only refer to a male and female plug-in component respectively. Preferably, the plug should generally be a replaceable switch module, especially a trigger module, which ideally cooperates with a circuit breaker, whereby the circuit breaker forms or comprises the mating plug. The plug is especially devised for receiving a plug insert with several contacts and the mating plug is devised for receiving a mating plug insert with several complementary contacts, whereby each contact can be connected to electrical conductors.

The switching arrangement according to an embodiment of the invention offers the benefit that most effort required for establishing the plug connection can be overcome by turning in the threaded bolt instead of applying pressure on the plug. It is also advantageous according to an embodiment of the invention, that the plug is disconnected from the mating plug by driving the thread of the locking bolt out of the mating thread without exerting significant tensile force, here.

According to a preferred embodiment, the thread and the mating thread have such a pitch to ensure that half a rotation of the locking bolt around its axis corresponds to a relative movement of the plug against the mating plug along its axis between the connected and disconnected position. The connected position means that the plug is inserted into the mating plug until it reaches the stop, and the disconnected position is reached as soon as the significantly high plugging force is overcome. This is regularly the case after over half a millimetre and less than five millimetres, especially after less than three millimetres and particularly preferred after less than two millimetres. Accordingly, the thread and the mating thread each have a pitch between two millimetres up to five millimetres, preferably around 3.5 millimetres. Furthermore, the thread and the mating thread are preferably embodied in a self-locking fashion, whereby preferably the connection is not separated unintentionally by an external force other than the rotation of the locking bolt.

According to a further preferred embodiment, in the axial direction the locking bolt is secured to the plug. The axial direction refers to the direction of the axis of rotation of the locking bolt. The locking bolt is therefore underpinned especially in the axial direction by the plug, preferably in both directions. In this manner, the locking bolt can be rotated preferably against the plug, however, it cannot be shifted in the axial direction. Any shifting in the radial direction is preferably not possible, either.

Preferably the locking bolt is driven to the plug in a guide. The guide can be embodied as a drilled hole through the plug. Preferably the locking bolt has a header, whereby the header acts on the counter-stop of the plug, whereby preferably the locking bolt can be fixed in a first axial direction.

Particularly preferred, at least a section of the guide is devised in the plug as a guide groove. A side of the guide can thereby be open, which can be implemented as an undercut guide groove. Alternatively, the guide grove can be at least partially closed by a cover for fixing the locking bolt in the radial direction.

According to a further preferred embodiment, the plug has at least one detachable lock washer, whereby the locking bolt has at least one circular safety groove, whereby the lock washer engages the safety groove. According to a preferred embodiment, the locking bolt is axially fixed by a lock washer in both directions. The guide groove does not require any further undercut. The lock washer is preferably detachable for removing the locking bolt, in the axial direction in case of a closed guide or in the radial direction in case of an open guide.

Particularly preferred, there are a number of detachable lock washers installed in the plug, whereby the locking bolt has a number of safety grooves, whereby each lock washer engages one of the safety grooves.

According to a further preferred embodiment an actuation lock is provided for securing the locking bolt. This prevents the actuation of the device, that is, it prevents screwing in or out the locking bolt, especially when the switching arrangement is operating. The actuation lock consists preferably of a slide, whereby in a locked position, the slide prevents the rotation of the locking bolt. For example, the slide covers the head of the locking bolt as a protective cap to prevent the insertion of a screwdriver. Particularly preferred, the slide can be moved from an unlocked position to a locked position and back by an actuator at the plug. For example, a protective cap at the plug, which covers the controls can be preferably connected mechanically to the slide to ensure that closing the flip cap causes the slide to move into the locked position, and the locking bolt is released by opening the cap. Here, the slide glides in a channel, whereby the channel is formed in a cover of the plug and whereby the flip cap is also swivelled at the cover. A corresponding transmission transforms the swivelling movement of the flip cap into a linear movement of the slide, for example.

According to a further preferred embodiment, the mating plug is attached to a circuit breaker, whereby the plug is allocated to a replaceable auxiliary module.

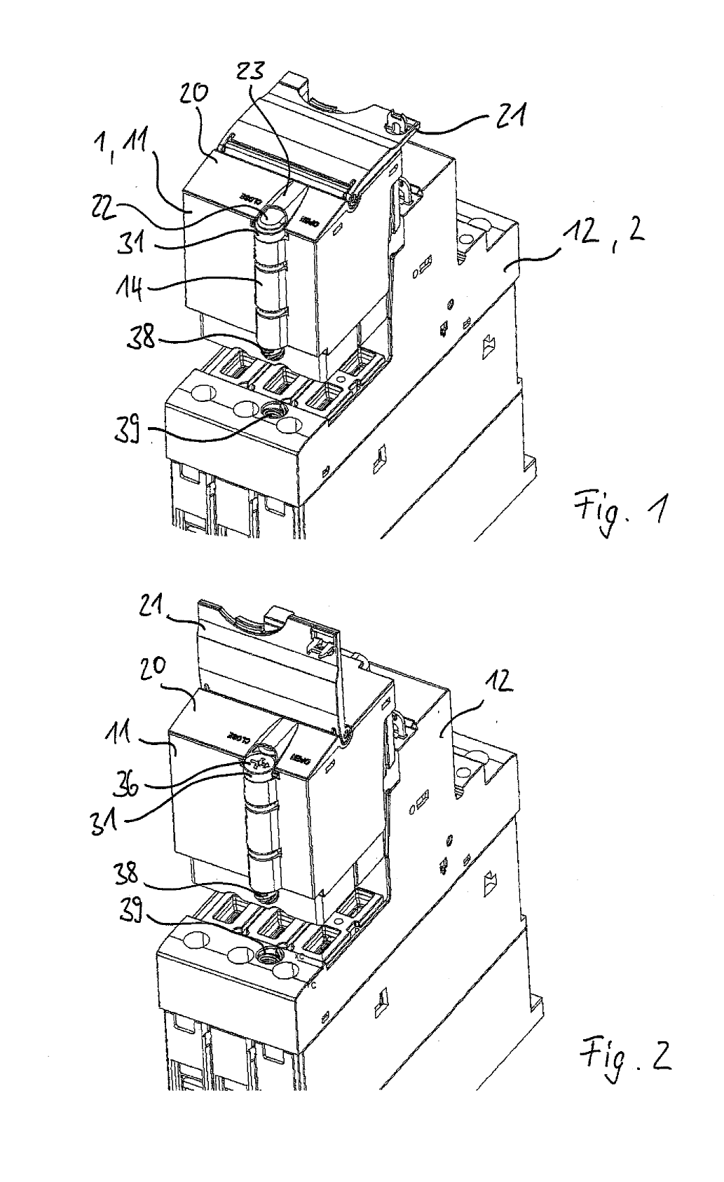

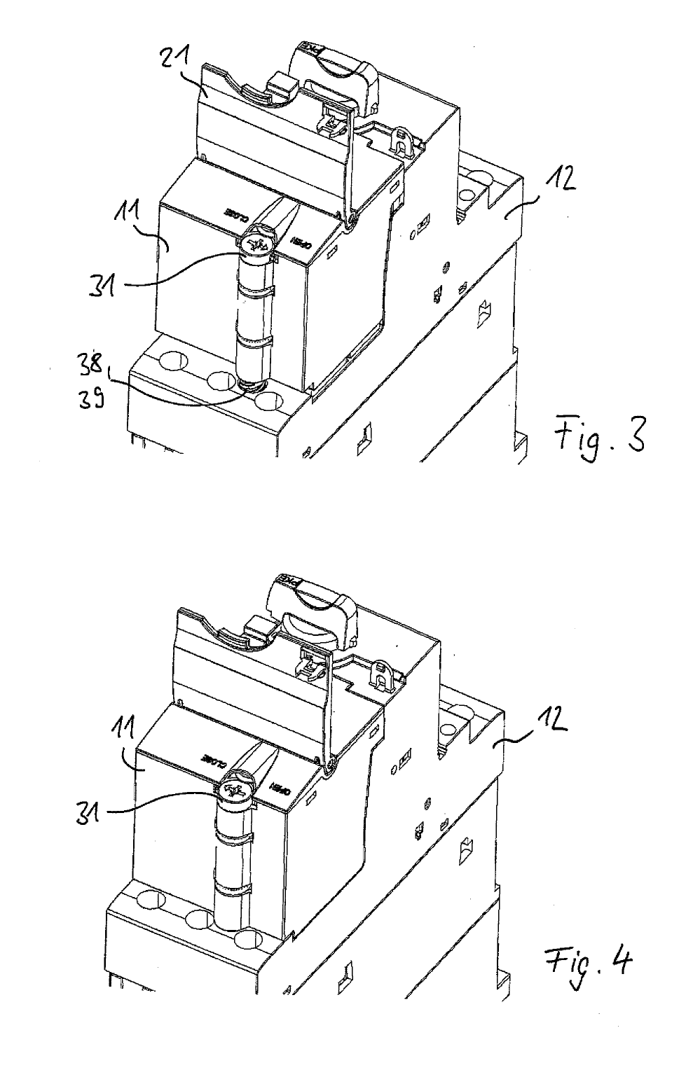

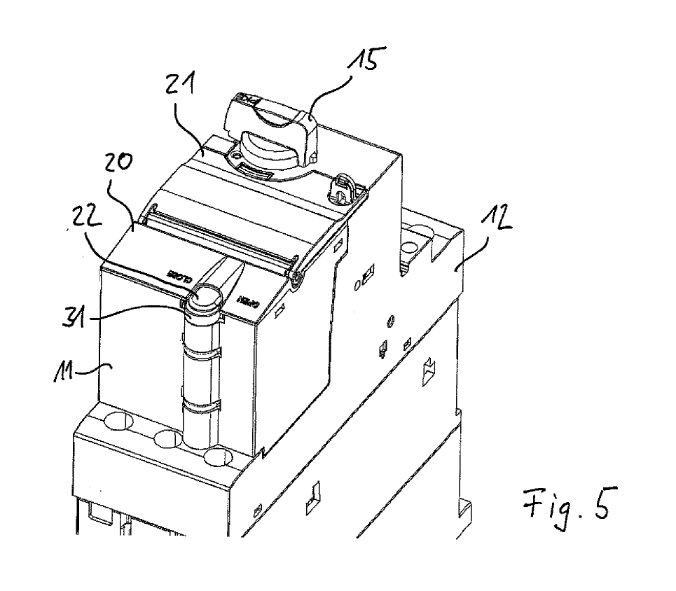

FIGS. 1 to 5 show a switching arrangement according to an embodiment of the invention, with a mating plug 12 at a circuit breaker 2 and a plug 11 at an auxiliary module 1, which can be attached to the circuit breaker housing. The auxiliary module 1 can be for example an electronic or mechanic trigger module, which turns off the circuit breaker 2 upon reaching certain adjustable parameters. The parameter can be for example the temperature of a motor to be switched or the current flow through the motor terminals. The circuit breaker 2 is fitted with a manually operated handle 15 (FIG. 4) for switching on and off the circuit breaker 2, if the auxiliary module 1 is connected to the circuit breaker 2 and secured. In FIG. 1, the auxiliary module 1 is presented aligned to the circuit breaker 2, however, plug 11 is still completely separated from the mating plug 12. According to an embodiment of the invention, there is a locking bolt 31 rotating around an axis 32 attached to the plug 11, whereby the locking bolt has a thread 38 and a mating thread 39 is arranged at the mating plug 12. In the presented embodiment, the plug 11 has an actuation lock 22, which prevents the plug 11 from connecting to or separating from the mating plug 12, whereby the locking bolt 31 is covered by a slide 22. The cross-shaped cut for a screwdriver in the head 36 (FIG. 2) becomes inaccessible in this manner. The slide 22 is preferably linked to a flip cap 21, which is linked swivelled to the cover 20 of the plug 11. There are for example setting controls for the switching module 1 arranged under the flip cap 21. The flip cap 21 is connected to slide 22 in a manner that slide 22 is pushed out of channel 23 when the flip cap 21 is closed to ensure that the head 36 of the locking bolt 31 is covered.

FIGS. 2 to 4 show how the circuit breaker 2 is connected to an auxiliary module 1. FIG. 2 shows the plug 11 in the same position, (the plug) 10 as in FIG. 1, however, the flip cap 21 is open and therefore the slide 22 of the actuation lock is retracted in the channel 23 such that the head 36 of the locking bolt 31 is accessible.

FIG. 3 shows the auxiliary module 1 inserted in an accept of the circuit breaker 2, and therefore the plugging procedure has started for establishing a connection between the plug 11 and the mating plug 12. There is a significant force required for plugging in approximately the last two millimetres of the plugging movement. The plug 11 is connected with the mating plug 12 by driving in the thread 38 of the locking bolt into the mating thread 39. In the position shown in FIG. 3, the thread 38 of the locking bolt 31 is already engaged, however, it is not yet driven into the mating thread 39. The arrow mark on the head 36 is now rotated from the position designated with the “open” mark into the positioned marked “close”. After half a rotation of the locking bolt 31, the plug 11 is connected to the mating plug 12 as presented in FIG. 4. The connection is established between the circuit breaker 2 and the auxiliary module 1. The locking bolt 31 is driven out for disconnecting the connection.

FIG. 5 shows the plug 11 again connected with the mating plug 12, and additionally with the actuation lock 22. By closing the flip cap 21, the slide 22 is pushed out of the channel 23 over the head 36 of the locking bolt 31. This means that the flip cap 21 can only be closed if the locking bolt is in its predefined position and it does not protrude from the guide 14. By closing flip cap 21, the locking bolt 31 is secured by the slide 22 against turning out during operation. If the circuit breaker 2 is set into operation with the handle 15 with the flip cap 21 closed, handle 15 blocks the flip cap 21, so that the flip cap 21 can only be opened when the circuit breaker 2 is switched off. The flip cap must be opened before disconnecting the circuit breaker 2 and the plug module 1 to ensure that the slide 22 is again drawn back into the channel 23 and thus the locking bolt 31 is released.

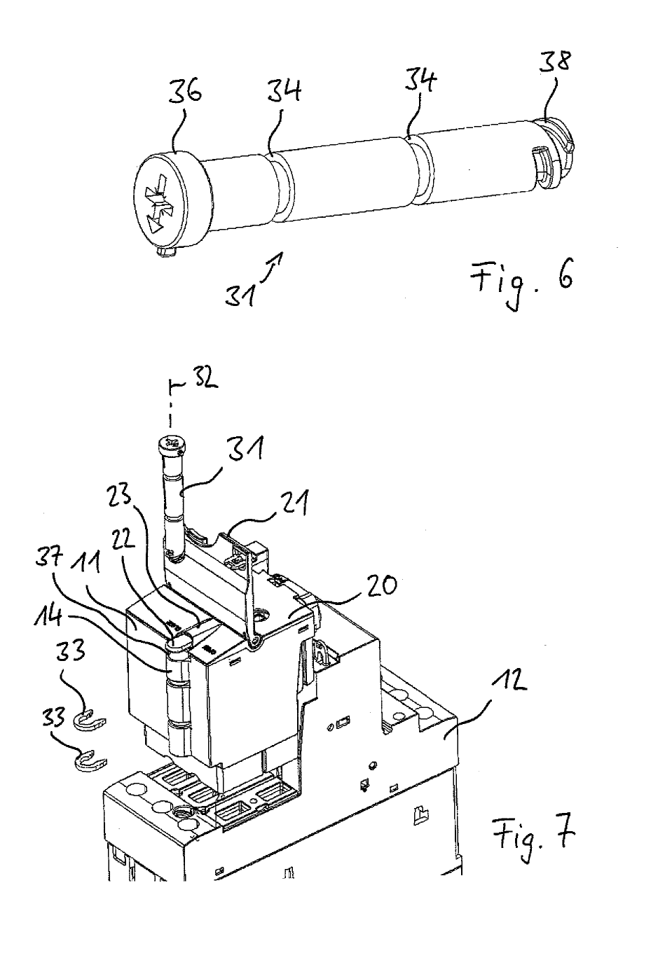

FIG. 6 shows a magnified view of the locking bolt 31. The thread 38 with particularly high pitch is shown besides the safety groove 34. The pitch is preferably two to five millimetres high to ensure that half a rotation of the locking bolt 31 causes an axial displacement of the plug by approximately one to two and a half millimetres, which is enough to overcome the area requiring significantly high plugging in effort.

FIG. 7 shows the exploded view of the components according to an embodiment of the invention of the plug 11 with the mating plug 12. There is a guide 14 at least as a partially closed groove on the surface of the plug 11 for accepting the locking bolt 31. Lock washers 33 are connected to the plug 11 by engaging the safety grooves 34 of the locking bolt 31, when the locking bolt is inserted into the guide 14. This mechanism ensures that the locking bolt 31 is fixed along its axis of rotation 32. Driving in the thread 38 into the mating thread 39 causes therefore no axial movement of the locking bolt 31 in reference to the plug 11, but due to the transmission of power the plug 11 is pulled via the lock washers 33 and the head 36 to the plug 11 and/or by the mating stop 37 to the mating plug 12. In the reverse direction, by driving out, the plug 11 is pulled out from the mating plug 12.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

1 Auxiliary module
2 Circuit breaker
11 Plug
12 Mating plug
14 Guide
15 Handle
20 Cover
21 Flip cap
22 Actuation lock/slide
23 Channel
31 Locking bolt
32 Axis of rotation
33 Lock washers
34 Safety grooves
36 Head
37 Counter-stop
38 Thread
39 Mating thread

1. A switching arrangement, comprising:
a plug and a complementary mating plug for establishing and separating a connection between the plug and the mating plug, the plug including a locking bolt disposed rotationally about an axis, the locking bolt including a thread and the mating plug including a mating thread, the plug being lockable to the mating plug by driving in the thread of the locking bolt into the mating thread wherein the switching device is configured to be moved to a connected position by driving in the thread of the locking bolt into the mating thread, and thereby providing a movement of the plug relative to the mating plug, and is configured to be moved to a disconnected position by driving out the thread of the locking bolt from the mating thread, thereby providing the movement of the plug relative to the mating plug.

2. The switching arrangement according to claim 1, wherein a pitch of the thread and the mating thread provides that half a rotation of the locking bolt around the axis corresponds to the movement of the plug relative to the mating plug along the axis between the connected position and the disconnected position.

3. The switching arrangement according to claim 2, wherein the pitch of the thread and the mating thread is between 2 and 5 mm.

4. The switching arrangement according to claim 1, wherein the thread and the mating thread are embodied in a self-locking fashion.

5. The switching arrangement according to claim 1, wherein the locking bolt is secured against the plug in the axial direction.

6. The switching arrangement according to claim 1, wherein the plug includes a guide through which the locking bolt is driven.

7. The switching arrangement according to claim 1, wherein the locking bolt has a head area which cooperates with a counter-stop on the plug.

8. The switching arrangement according to claim 6, wherein at least a section of the guide is configured as a guide groove on the plug.

9. The switching arrangement according to claim 1, further comprising at least one detachable lock washer disposed at the plug, wherein the locking bolt has at least one circular safety groove, whereby and wherein the lock washer is configured to engage the safety groove.

10. The switching arrangement according to claim 9, further comprising a plurality of the detachable lock washers disposed at the plug, wherein the locking bolt has a plurality of the circular safety grooves, and wherein each of the lock washers is configured to engage one of the safety grooves.

11. The switching arrangement according to according to claim 1, further comprising an actuation lock fitted to secure the locking bolt.

12. The switching arrangement according to claim 11, wherein the actuation lock includes a slide, whereby in a locked position, the slide prevents the rotation of the locking bolt.

13. The switching arrangement according to claim 12, wherein the slide is movable from an unlocked position to the locked position and back by an actuator disposed at the plug.

14. The switching arrangement according to claim 1, wherein the mating plug is attached to a circuit breaker and the plug is allocated to a replaceable auxiliary module.

15. The switching arrangement according to claim 2, wherein the pitch of the thread and the mating thread is around 3.5 mm.
